(19) United States
(12) Patent Application Publication
(10) Pub. No.: US 2017/0153197 A1
(43) Pub. Date: Jun. 1, 2017

(54) Contamination Meter

(71) Applicant: ELCOMETER LIMITED, Manchester (GB)

(72) Inventors: Michael John Shanahan, Cheshire (UK); John Joseph Maguire, Manchester (UK)

(21) Appl. No.: 15/322,830

(22) PCT Filed: Jun. 30, 2015
(86) PCT No.: PCT/GB2015/051908

§ 371 Date: Dec. 29, 2016

(30) Foreign Application Priority Data
Jun. 30, 2014 (GB) 1411635.4

(51) Int. Cl. G01N 27/07

(52) U.S. Cl. CPC G01N 27/07

(57) ABSTRACT

A contamination meter (1) for measuring salt concentration on a surface by measuring the electrical resistance of a test medium which has been applied to the surface is disclosed. The meter (1) has at least two electrodes (9) arranged to be brought into contact with the test medium. A measuring device is arranged to measure the electrical resistance of the test medium between one or more pairs of electrodes (9), thereby to measure the electrical resistance of the test medium between the or each pair of electrodes (9) when the electrodes (9) are brought into contact with the test medium. The electrodes (9) are arranged such that, in use, the resistance of the test medium is measurable between pairs of electrodes (9) at different positions on the medium without any relative movement between the medium and the contamination meter (1). The electrodes (9) may be arranged in a grid, and an electrical resistance measurement may be made between any pair of electrodes (9).

### TECHNICAL FIELD OF THE INVENTION

The present invention relates to a contamination meter for measuring salt concentration on a surface by measuring the electrical resistance of a test medium which has been applied to the surface.

### BACKGROUND TO THE INVENTION

When coating a metal surface with, for example, paint, it is desirable to know the concentration of salts on the surface prior to coating since, over time, the presence of salt can accelerate corrosion and damage to the surface being treated. By measuring the salt concentration on the surface it is possible to determine how much cleaning of the surface is required prior to coating and also to determine when the salt concentration levels are sufficiently low for coating to commence.

One way in which surface contamination is measured is known as the Bresle method which is the current industry standard for determining acceptable salt concentration levels prior to coating. The Bresle method involves applying a self-adhesive rubber film patch to the surface so that a compartment is formed between the surface and the patch. A known quantity of deionised water is then injected into the compartment to cause any soluble salts present on the surface to dissolve in the water. The salt solution is then extracted from the patch using a syringe and its conductivity is measured. Since the volume of water used, the area of the patch and the initial conductivity of the water are all known, using the measured conductivity of the salt solution, it is possible to calculate the average salt concentration present on the surface under the patch. A problem with the Bresle method, though, is that it is messy and awkward to carry out.

An alternative, simpler apparatus for measuring the concentration of salt on a surface comprises an electrically-insulating base plate having a circular central electrode and an outer annular electrode concentric with the central electrode. The apparatus is arranged to receive a wetted test medium which has been applied to a surface of interest for a predetermined period and to measure the electrical resistance between the electrodes across the wetted test medium. The measured resistance value is converted to a measure of salt contamination to determine whether the contamination level of the surface is within acceptable limits to be coated.

There are two key potential issues with this existing apparatus. Firstly, the apparatus measures the maximum concentration of salt between the two electrodes across a subset of the area between the electrodes. In practice, salt deposits are not usually uniformly distributed across a surface to be tested, even at the scale of 100 cm², so the measured value does not necessarily give a measure of the average salt concentration across the whole area being tested. Secondly, the area between the electrodes is typically less than half the entire area of the test medium. Therefore, to estimate the conductivity of the entire area of the test paper, an assumption must be made that the average salt concentration is the same outside the test area as in the test area. For this reason, existing apparatus can only be said to provide an approximate average salt concentration and does not necessarily reflect high or low concentrations of soluble salts across the entire measurement areas.

It is an object of embodiments of the present invention to provide an improved contamination meter that will provide a more accurate measure of the salt concentration of a surface.

### SUMMARY OF THE INVENTION

According to an aspect of the present invention, there is provided a contamination meter for measuring salt concentration on a surface by measuring the electrical resistance of a test medium which has been applied to the surface, the meter comprising at least two electrodes arranged to be brought into contact with the test medium, and a measuring device arranged to measure the electrical resistance of the test medium between one or more pairs of electrodes thereby to measure the electrical resistance of the test medium between the or each pair of electrodes when the electrodes are brought into contact with the test medium, wherein the electrodes are arranged such that, in use, the resistance of the test medium is measurable between pairs of electrodes at different positions on the medium without any relative movement between the medium and the contamination meter.

Advantageously, apparatus according to the present invention is capable of providing a more accurate value for the mean salt density across a test medium and is therefore capable of providing a more accurate measure of salt contamination of a surface to be coated. The measurements taken by apparatus according to the invention are likely to be closer to a Bresle method measurement than that of existing devices. Further, apparatus according to the present invention enables the salt concentration at different regions across the test medium to be mapped.

There may be at least three electrodes. There may be more than three electrodes.

At least one, more than one or each electrode may be movable relative to the contamination meter. Each electrode may be moveable in a direction parallel to the part of the test medium the electrodes are brought into contact with. Or, for embodiments with three or more electrodes, all electrodes may be fixed relative to the meter, at least when the meter is in use.

The meter may comprise at least one row of electrodes. There may be at least five rows and at least five electrodes in each row. Each electrode in a row may be substantially equally spaced apart from each adjacent electrode in the row. Each row may be substantially parallel with each other row. Each row may be substantially equally spaced apart from an adjacent row. The electrodes may be arranged in a grid.

The test medium may be a sheet of material and the meter may be arranged to receive the sheet of material and to retain the sheet of material so that the sheet of material is brought into contact with at least two electrodes.

The electrodes may be arranged in an array. The array may extend over at least 50% of the area of a side of the sheet of material. The array may extend over at least 75% of the area of a side of the sheet of material. The array may extend over substantially all of the area of a side of the sheet of material.

The meter may comprise a substantially flat surface and the electrodes may be arranged on the surface such that the electrodes form a contact surface for a test medium.

The meter may further comprise a piece arranged to sandwich a test medium between the piece and the contact surface.

The meter may be arranged to measure the electrical resistance between at least two different pairs of electrodes and to store each measured resistance value.

The meter may be arranged to determine the concentration of salt on a test medium and the meter may further comprise a calculation engine to calculate a mean value for the average salt concentration on the test medium and salt concentration values between pairs of electrodes based upon the measured resistance values between pairs of electrodes.

The meter may further comprise a display to show a representation of the measured resistance values and/or the calculated average salt concentration and/or the calculated salt concentration levels between pairs of electrodes and/or a map of the salt concentration levels between pairs of electrodes.

For each electrode, the resistance of the test medium may be measurable between that electrode and at least one other electrode.

According to another aspect of the invention there is provided a contamination meter for measuring salt concentration on a surface by measuring the electrical resistance of a test medium which has been applied to the surface, the meter comprising at least three spaced apart electrodes arranged to be brought into contact with the test medium, and a measuring device arranged, in use, to measure the electrical resistance between two or more pairs of the electrodes thereby to measure the electrical resistance of the test medium between different positions on the medium.

The second aspect of the present invention may incorporate any or all features of the first aspect of the present invention, as desired or as appropriate.

### DETAILED DESCRIPTION OF THE INVENTION

In order that the invention may be more clearly understood an embodiment thereof will now be described, by way of example only, with reference to the accompanying drawings, of which:

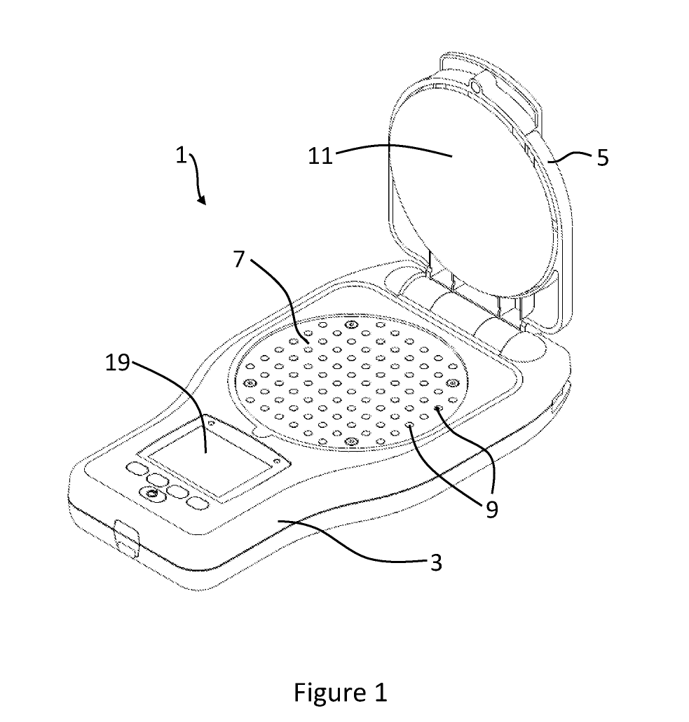

FIG. 1 shows a perspective view of a meter according to the present invention;

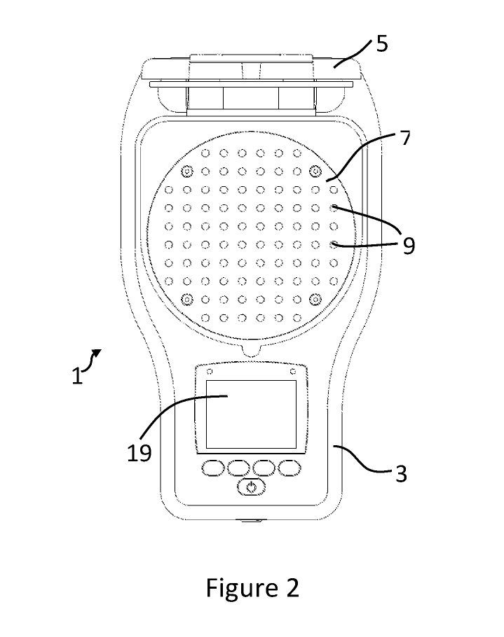

FIG. 2 shows a plan view of the meter shown in FIG. 1; and

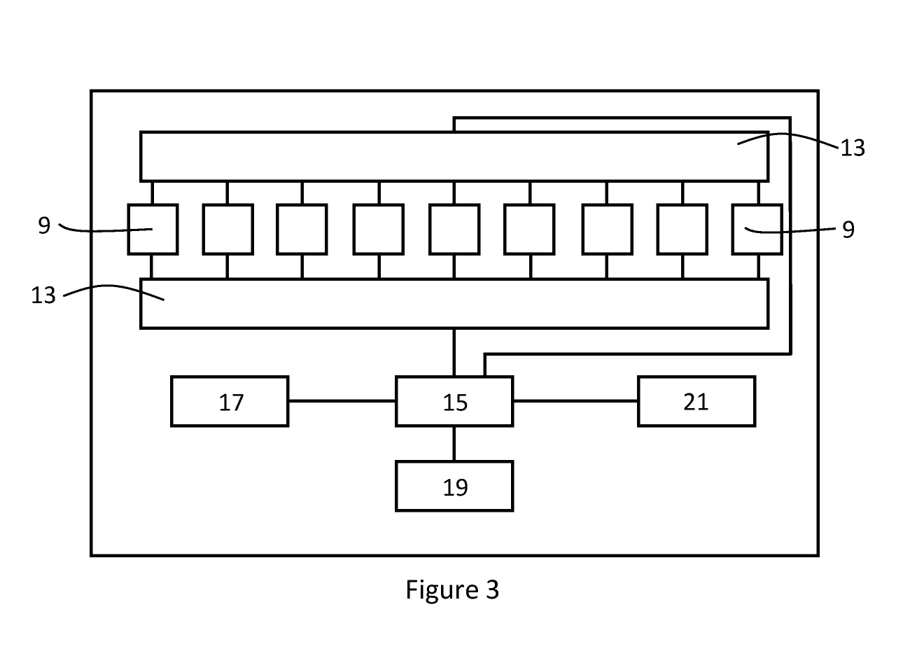

FIG. 3 shows a schematic representation of electronic components of the apparatus shown in FIG. 1.

With reference to the drawings, there is shown a contamination meter 1 comprising a handheld body 3 and a lid 5 which is hingedly mounted at one end to the body 3. The body 3 comprises a shallow substantially circular recess 7 approximately 115 mm in diameter which is formed in one face of the body 3 and which is arranged relative to the lid 5 such that when the lid 5 is moved to a closed position, the recess 7 is covered by the lid 5. The recess 7 and lid 5 together form a cavity for a sheet of filter paper (not shown) which is dimensioned to conform closely to the shape of the recess 7.

The recess 7 comprises a plurality of copper electrodes 9 which are arranged in a series of substantially parallel equally spaced apart rows at the base of the recess which is made from a non-absorbent, non-conducting material. Each row of electrodes 9 terminates close to the perimeter of the recess 7 and together form a cross shaped grid which extends over the majority of the recess 7. Whilst a cross shape is used in this embodiment, other suitable grid shapes may be used such as a circular, hexagonal or rectangular. Each electrode 9 is separated from each adjacent electrode 9 in the row or between rows by approximately 10mm and arranged such that their respective upper surfaces are substantially in the same plane so that they all come into direct contact with the filter paper when the paper is placed in the recess 7. The electrodes 9 form an array which is arranged to extend across a substantial part of the area of one side of a sheet of filter paper. Preferably, the array extends across more than 90% of the area of the sheet.

The lid 5 comprises a substantially circular pad 11 which is arranged to apply pressure to the filter paper when the paper is positioned between the electrodes and the pad 11 so that the paper is urged into good contact with the electrodes when the lid 5 is closed.

The electrodes 9 are arranged on a printed circuit board as a multi-channel grid and individually connected to two multiplexers 13 via respective communication channels. The multiplexers 13 are operatively connected to a microcontroller 15 which contains analogue to digital converters so that the signals from the multiplexers can be quantified and centrally processed. The multiplexers 13 are arranged such that two electrodes can be selected at any one time so that a voltage can be applied between the chosen pair of electrodes. The multiplexers 13 are operable to select different pairs of electrodes 9 at different times so that each pair of electrodes of the grid can be selected in sequence.

The microcontroller 15 is operatively connected to a solid state memory storage module 17 for storing measured data and also connected to a liquid crystal display (LCD) 19 so that measurements can be graphically and numerically displayed to a user of the meter 1. The microcontroller 15 is also connected to a communications port 21 which comprises a USB connector and a wireless Bluetooth® transceiver to enable recorded data from the meter to be communicated to a computer for further analysis.

In use, a substantially circular sheet of high purity sample paper having a diameter of approximately 110 mm and capable of absorbing a known quantity of water is saturated with 1.6 ml of demineralised water and applied to a surface to be coated using tweezers. The paper is allowed to remain on the surface for approximately 2 minutes to enable salts on the surface to be absorbed into the paper to form a salt water solution.

After 2minutes, the contaminated paper is placed in the recess 7 on the electrodes and the lid 5 is closed so as to urge the paper into contact with the electrodes 9. The meter 1 is then activated and the multiplexers 13 are operated so as to select a first pair of adjacent electrodes 9 in a first row and apply a voltage there between. The resistance across the filter paper between the electrodes 9 is then determined and processed by the microcontroller 15 and stored in the storage module 17. Using time division multiplexing, the process is repeated for each adjacent pair of electrodes 9 in each row until resistance values between each pair of adjacent electrodes of each is determined. This cycle of measurements can be conducted at a high enough rate so as to be essentially simultaneous. Thus, a user of the device is unaware of any time delay.

Whilst the above measurement sequence involves measuring the resistance between each adjacent pair of electrodes in each row, it is envisaged that any pair of electrodes in the grid can be selected by the multiplexers. Thus, it is possible to measure, for example, the resistance between a pair of electrodes on opposite sides respectively of the grid or to measure the resistance between every possible combination of pairs in the grid. Since the distance between each electrode 9 is known, the resistivity between each electrode may be calculated by the microcontroller 15 based upon the measured resistance values.

The solution concentration on the filter paper is inversely proportional to its resistivity so by measuring the resistivity of the filter paper between electrodes 9 it is possible to determine the salt concentration between electrodes 9. When all resistivity measurements between electrodes have been determined, a mean salt concentration value for the entire sheet of material is calculated by averaging the resistivity measurements. The reading is automatically displayed on screen and stored into the memory module together with the filter paper size, temperature, date and time. Using the measured resistivity values between each electrode 9, it is also possible to plot the salt density on the filter paper between each electrode 9 graphically on the display 19 so that the user of the meter 1 can clearly identify areas of high salt concentration. Such a graphical representation may comprise different colours according to a concentration scale to show differing levels of salt concentration across the filter paper.

In a second embodiment, each electrode 9 is movable relative to the recess 7, in two directions along a plane parallel to the recess 7. The movement of each electrode is controlled by microcontroller 15, and the electrodes 9 are able to move into contact with different positions across the face of the filter paper. When the meter 1 is activated, the multiplexers 13 are operated so as to select a pair of electrodes 9 in a first position and apply a voltage there between. The resistance across the filter paper between the electrodes 9 is then determined and processed by the microcontroller 15 and stored in the storage module 17. Microcontroller 15 then moves the pair of electrodes 9 to a new position, via a motor. The new position is selected from a set of positions stored in the storage module 17, the set of positions having been inputted to the storage module 17 when the meter 1 was manufactured. The above process can be repeated for all the positions specified by the set of positions, at which point a mean salt concentration may be calculated and/or the measurements may be displayed, numerically or graphically, via the display screen 19.

Alternatively, the user may input a set of positions into the storage module 17 for the electrodes 9 to move to and for resistance measurements to be taken at, via an input method and display screen 19.

The above embodiments are described by way of example only. Many variations are possible without departing from the scope of the invention as defined in the appended claims.

1. A contamination meter for measuring salt concentration on a surface by measuring the electrical resistance of a test medium which has been applied to the surface, the meter comprising at least two electrodes arranged to be brought into contact with the test medium, and a measuring device arranged to measure the electrical resistance of the test medium between one or more pairs of electrodes thereby to measure the electrical resistance of the test medium between the or each pair of electrodes when the electrodes are brought into contact with the test medium, wherein the electrodes are arranged such that, in use, the resistance of the test medium is measurable between pairs of electrodes at different positions on the medium without any relative movement between the medium and the contamination meter.

2. A contamination meter as claimed in claim 1, wherein there are at least three electrodes.

3. A contamination meter as claimed in claim 1, wherein at least one, more than one or each electrode is movable relative to the contamination meter.

4. A contamination meter as claimed in claim 3, wherein at least one, more than one or each electrode is moveable in a direction parallel to the part of the test medium the electrodes are brought into contact with.

5. (canceled)

6. A contamination meter as claimed in claim 1 comprising at least one row of electrodes.

7. A contamination meter as claimed in claim 6, wherein there are at least five rows and at least five electrodes in each row.

8. A contamination meter as claimed in claim 6, wherein each electrode in a row is substantially equally spaced apart from each adjacent electrode in the row.

9. A contamination meter as claimed in claim 6, wherein each row is substantially parallel with each other row.

10. A contamination meter as claimed claim 6, wherein each row is substantially equally spaced apart from an adjacent row.

11. A contamination meter as claimed in claim 1, wherein the electrodes are arranged in a grid.

12. A contamination meter as claimed in claim 1, wherein the test medium is a sheet of material and the meter is arranged to receive the sheet of material and to retain the sheet of material so that the sheet of material is brought into contact with the at least two electrodes.

13. A contamination meter as claimed in claim 12, wherein the electrodes are arranged in an array which extends over at least 50% of the area of a side of the sheet of material.

14. A contamination meter as claimed in claim 13, wherein the array is arranged to extend over at least 75% of the area of a side of the sheet of material.

15. A contamination meter as claimed in claim 14, wherein the array is arranged to extend over substantially all of the area of a side of the sheet of material.

16. A contamination meter as claimed in claim 1, wherein the meter comprises a substantially flat surface and wherein the electrodes are arranged on the flat surface such that the electrodes form a contact surface for a test medium.

17. A contamination meter as claimed in claim 16, further comprising a piece arranged to sandwich a test medium between the piece and the contact surface.

18. A contamination meter as claimed in claim 1, arranged to measure the electrical resistance between at least two different pairs of electrodes or between a pair of electrodes when located in each of at least two different positions and to store each measured resistance value.

19. A contamination meter as claimed in claim 1, wherein the meter is arranged to determine the concentration of salt on a test medium and wherein the meter further comprises a calculation engine to calculate a mean value for the average salt concentration on the test medium and salt concentration values between pairs of electrodes based upon the measured resistance values between pairs of electrodes.

20. A contamination meter as claimed in claim 18, further comprising a display to show a representation of the measured resistance values and/or the calculated average salt concentration and/or the calculated salt concentration levels between pairs of electrodes and/or a map of the salt concentration levels between pairs of electrodes.

21. A contamination meter as claimed in claim 1, wherein for each electrode, the resistance of the test medium is measurable between that electrode and at least one other electrode
